(19) United States
(12) Patent Application Publication
(10) Pub. No.: US 2018/0040086 A1
(43) Pub. Date: Feb. 8, 2018

(54) TOOL FOR CLOSING ADMISSIONS FOR A SCHOOL

(71) Applicant: Chegg, Inc., Santa Clara, CA (US)

(72) Inventors: Rahul Ravindra Mutalik Desai, San Jose, CA (US); Fei Sha, Santa Clara, CA (US); Ben Van Roo, Santa Clara, CA (US); Seth Kadish, Santa Clara, CA (US); Dax Eckenberg, Los Gatos, CA (US); Michael Osier, Santa Clara, CA (US); Jason Schnitzer, Santa Clara, CA (US)

(21) Appl. No.: 15/230,479

(22) Filed: Aug. 7, 2016

(51) Int. Cl. G06Q 50/20; G06Q 10/10

(52) U.S. Cl. CPC G06Q 50/2053; G06Q 10/10

(57) ABSTRACT

An admissions funnel process software application recommends a candidate to a school based on the admission cycle timeline of the school. The admission closing tool receives an admission schedule for a school that includes a set of admission goals for the school such as a desired number of students at each stage of an admission cycle. A candidate profile is compiled for each of a plurality of candidates. For each candidate, the admissions funnel process software application predicts a stage in the admission cycle that the candidate will be, at a future time. For each stage of an admission cycle, the candidates are aggregated by their predicted stages to obtain a predicted admissions cycle for the school. The aggregated number of candidates is compared to the desired number of candidates for that stage. Responsive to the comparing, one or more candidates are selected as leads, recommended and sent to the school.

### BACKGROUND

This invention relates generally to providing a software application associated with a school admissions funnel process, and more particularly recommending a set of candidates to a school based on the timing of the admission process of the school and a school's student admissions funnel.

### SUMMARY

An admissions funnel process software application recommends one or more candidates to a school based on a predicted admission cycle for the school. An admission cycle of a school may be defined as one or more stages that lead to enrollment of a student to the school for a specific course. A predicted admission cycle is described in the subsequent paragraphs. The admissions funnel process software application receives an admission schedule for a school. The admission schedule includes a set of admission goals that the school is looking to meet for the specific school year. The admission goals are typically per enrollment class per year for the school. An admission goal may be defined as the number of students desired by the school at the end of each stage of the admission cycle.

The admissions funnel process software application compiles a candidate profile for each of a plurality of candidates. A candidate profile is a compilation of information pertaining to a particular candidate. The information may be personal (e.g. location, race, gender, age, etc.) or academic (e.g. previously completed courses, grades, academic interests, social interests, etc.). Based on the candidate profile, the admissions funnel process software application predicts for each candidate, a likelihood of entering the next stage in the admissions cycle.

### BRIEF DESCRIPTION OF THE DRAWINGS

FIG. 1 illustrates the environment of an online admissions platform, according to one embodiment.

FIG. 2 is a diagram of functional components of an admissions funnel process software application for a school, according to one embodiment.

FIG. 3 is a diagram of an admission cycle time line, according to an embodiment.

FIG. 4 is a flow chart illustrating the method for recommending a candidate to a school based on the current time point of an admission cycle of the school, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Environment of an Online Admissions Platform

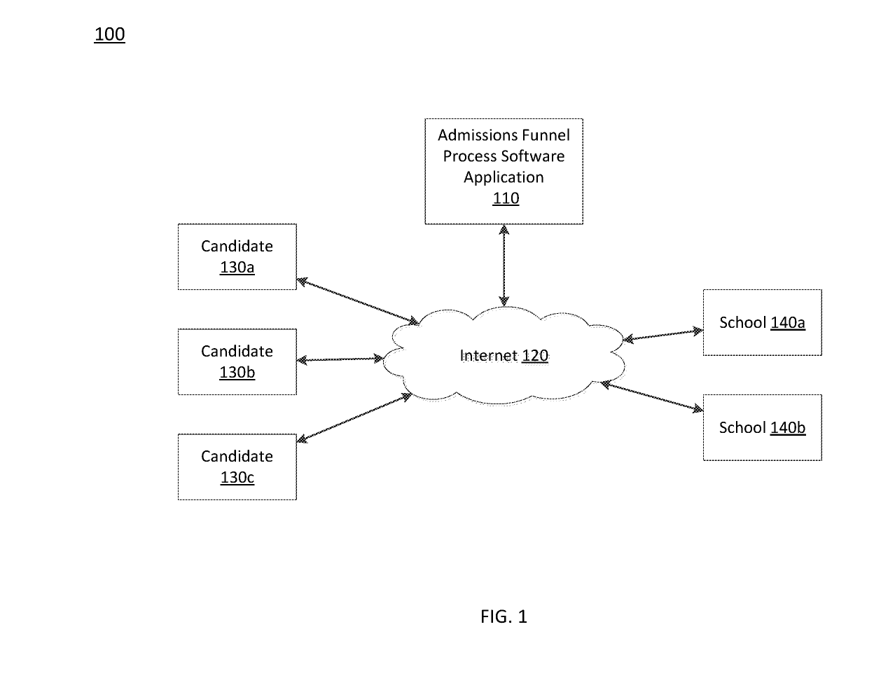

FIG. 1 is a diagram illustrating the environment of an online admissions platform, according to one embodiment. The environment 100 of the platform includes an admissions funnel process software application 110. The admissions funnel process software application 110 includes both a business-to-consumer (B2C) and business-to-business (B2B) components and is configured recommend a candidate to a school based on a predicted admissions cycle for a school and a set of admissions goal for the school (as will be described in detail later). The admissions funnel process software application 110 is connected via the Internet 120 to candidates 130 and schools 140. The admissions funnel process software application 110 is also connected via the Internet 120 to schools 140. Candidates 130a, 130b, and 130c and schools 140a and 140b are purely for example; the admissions funnel process software application 110 could simultaneously support thousands or even millions of candidates 130 and hundreds or thousands of schools 140.

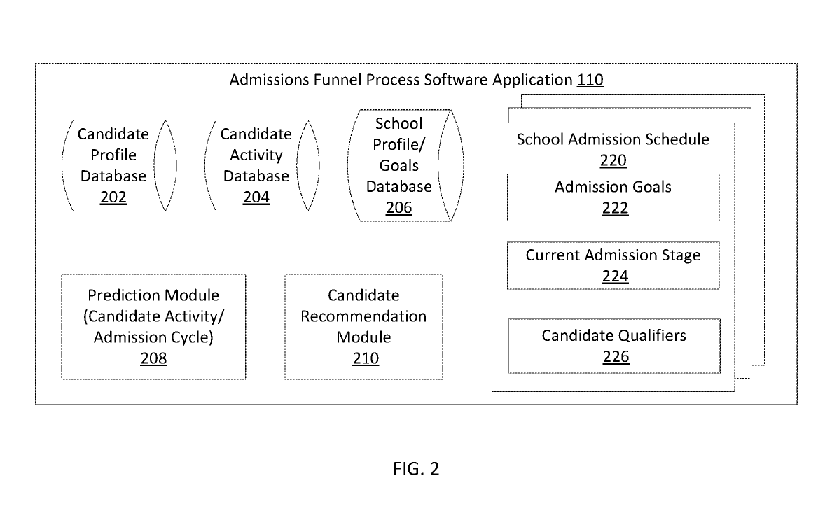

FIG. 2 is a diagram of functional components of an admissions funnel process software application for a school, according to one embodiment. The admissions funnel process software application 110 includes a candidate profile database 202, a candidate activity database 204, a school profile database 206, a candidate activity and admission cycle prediction module 208 (generally termed as prediction module 208), a candidate recommendation module 210 and a school admission schedule 220 for each school 140. The school admission schedule 220 further includes a set of admission goals 222, a candidates' admission stage 224 and candidate qualifiers 226.

The candidate profile database 202 is configured to store a collection of candidate profiles. Each candidate profile is a compilation of information pertaining to a particular candidate 130. This information could be personal (location, race, gender, etc.) or academic (previously completed courses, grades, academic interests, etc.). In one embodiment, each candidate profile is composed from information inputted by a candidate 130 via the online admissions platform 100.

The candidate activity database 204 is configured to store a record of candidate activities. In some embodiments, candidate activities include an expression of interest made by a candidate 130 toward a particular school 140. The expression of interest could be expressed as a like, comment, or subscription (for example, to an RSS feed) made in the context of an online recruiting platform. Additional candidate activities include accepting an admission offer from the school 140. In one embodiment, the candidate profile database 202 and candidate activity database 204 are consolidated into a single database.

The school profile database 206 is configured to store a collection of school profiles. Each school profile contains information describing a participating school, such as its location, selectivity, class size, disciplines/degrees offered, athletic programs, and so on. In one embodiment, a school profile includes information entered by a school administrator or admissions officer via an interface of the online admissions platform. School profile information may also be compiled or aggregated from sources that are publicly available on the Internet, such as on forums, blogs, and other websites.

In one embodiment, the school profile database 206 may include admission goals for each school. For example, each school may have a generic admission goal such as filing up the class within a specific time line, or accepting students above a specified grade point or any other such admission goal/constraint.

For each school, a school admission schedule 220 is determined and stored in the school profile database. The school admission schedule 220 includes the timeline of an admission cycle for the school, for example, the specific dates for each stage of the admission cycle, a set of admission goals 222 within each stage of the admission cycle, a current admission stage 224 and candidate qualifiers 226. An admission cycle includes one or more stages leading up to enrollment of a student at the school.

The set of admission goals 222 may include defining enrollment targets, for example, overall enrollment targets, enrollment targets by section, enrollment targets based on each stage of the admission cycle. Defining an enrollment target includes specifying the desired number of students or type of students for enrolling within a class for a specific academic year. For example, an overall enrollment target may include enrolling 100 students for a class by the end of an admission cycle. An enrollment target by section may include defining the desired number of athletic students, or desired number of students from a particular region, race or ethnicity. An enrollment target based on each stage of the admission cycle may include specifying the desired number of students at each time point of the admission cycle, for example, the school may have a goal of sending admits to at least 150 students by the end of “admitted” stage of an admission cycle.

The admission goals 222 may further include specifying desired number of retention targets. Retention targets may include specifying the desired number of students for graduation for the academic year and/or desired number of students progressing to the subsequent academic year of their class. For example, a retention target for graduation may include at least 10 students graduating per class every year, or at least 50% students enrolling in the subsequent years.

A current admission stage 224 may include determining the current stage of an admission cycle. For example, the admission schedule of a school may specify that the fall classes start from August; the current admission stage 224 module may detect the current month as February and thus determine that the school is in the “prospects” stage. In addition to the current stage, the current admission stage 224 module may collect information associated with the current stage, such as number of prospects that match the school requirements in the prospect stage, or number of students enrolled so far in the admitted stage and other such information. In another embodiment, a school may be operating at multiple stages of an admission cycle. For example, a school may have a year round admissions process. In this case, the school may be in the prospect stage and admit stage of an admissions cycle. In this embodiment, the current admissions stage 224 may gather information related to each of the multiple stages of the admissions cycle for the school. This information may be used by the prediction module 208, described in detail below.

A candidate qualifier 226 identifies a natural progression of a candidate within the admission cycle of the school, for a particular course. The candidate qualifier 226 indicates which stage of the admission cycle the candidate is currently in. For example, for an admission cycle, the typical qualifiers may be prospects, inquired, applied, admitted, enrolled, confirmed or any other such stage within the admission cycle. The candidate qualifier 226 may be updated by a school administrator, or may be automatically updated by the candidate qualifiers module 208, on receiving a candidate activity.

A prediction module 208 includes one or more predictors that determine a predicted admission cycle timeline for a school. A predicted admission cycle timeline includes predicting the number of students that will reach an admission stage of an admission cycle, at a future time. The prediction module 208 may include a number of prediction models for every stage within the admission cycle. For example, admission progress models such as a model to determine if a prospective student will apply to a school or not, a model to predict if a student applies, will the student be admitted or not, a model to predict an enrollment of the admitted student, a model to predict confirmation of an admitted or enrolled student, a model to prediction retention for first year of a confirmed student, a model to predict if a confirmed student will graduate from the school or not. Another set of prediction models includes time to decision models, for example, a prediction model to determine time taken by a prospective student to apply, a prediction model to determine time taken by an admitted student to enroll, or a prediction model to determine time take by a confirmed student to graduate, 4 years or 6 years. These are examples of prediction models, there may be many other such similar prediction models within the prediction module 208.

The set of prediction models determine the predicted admission cycle timeline for each school. For each school, school specific data may be used as a training set or input for the prediction models. School specific data may include tuition, student faculty ratio, location, historical performance among others attributes. Student specific data may include profile attributes such as gender, address, interests and grades. Each prediction model within the prediction module 208 may be ranked based on the school's historical data. For example, historically, the admitted stage predictions may be more important than the prospects stage for a school. For another school, finding prospects may be the most difficult part within the admission cycle, and thus the predictions within the prospects stage may be more important than other stages. The prediction models may be any computer model such as non-linear regression model or any other such model. Each admission progress prediction model may provide a score that indicates a likelihood of a candidate activity such as application, admission, enrollment or confirmation. Each time to decision prediction model may provide a predicted time value (in days, months, years, etc.) for a candidate activity such as time to apply, time to confirm, etc. Additionally, in some embodiments, the prediction models may provide a reason code behind the scores or time values. For example, an applicant in the admitted may highly likely enroll and the reason code may indicate that the applicant has filled up the enrollment form.

Base on the admission progress prediction output and the time to decision prediction output for each candidate, the prediction module 208 may predict a stage that each candidate may be in at a future time. For example, a prospective candidate may be predicted to enroll within 3 days of sending an admission offer, the candidate may be predicted to reach the “admitted” stage of the predicted admissions cycle timeline. A first year student may be predicted to confirm admission for the second year, such a candidate may be predicted to reach the “confirmed” stage of the predicted admissions cycle timeline.

The prediction module 208 then aggregates the candidates by their predicted stages, for each school. The prediction module 208 then obtains the current admissions stage 224 information and the admission goals 222 information for each school. The current admissions stage information indicates the current admission stage of the school and the admission goals 222 information provides the target enrollment for the current admission stage. For a current stage, or a future admission stage, the prediction module 208 may compare the predicted number of candidates to the target enrollment. Based on the comparison the prediction module 208 may determine if the school is within the target enrollment for the stage of the admission cycle. If under target, the prediction module 208 may further determine the likelihood of reaching the overall target enrollment within the admission stage timeline. The prediction module 208 may conclude that the school is not likely to reach its target enrollment within the admission stage timeline. Based on the comparison, the prediction module 208 may determine the desired number of candidates required to reach the target enrollment within an admission cycle stage or overall target enrollment and send this to the candidate recommendation module 210. For example, the prediction module 208 may determine that a school is short of 30 candidates for reaching the target enrollment, and may request the candidate recommendation module 210 to provide 40 candidates.

The candidate recommendation module 210 recommends one or more candidates as leads for a school. The candidate recommendation module 210 may receive a request from the prediction module 208. Additionally, the candidate recommendation module 210 may receive the current admission stage 224 for the school. Based on the current admission stage, the school requirements to fill a class and a candidate's profile that includes the candidate's qualifier and ranking, the candidate recommendation module 210 determines a list of potential candidates for the school. Each candidate in the potential candidate list is ranked. A candidate may be ranked based on a number of factors, such the school requirements for an upcoming class, the academic profile of a candidate, demographics of a candidate, the candidate's recorded level of engagements or activities and other such factors. For example, if the current admission stage for the school is “admitted” stage, a candidate in the “applied” stage may be ranked higher than a candidate in the “prospect” stage of the school. Further, a candidate that may have been “confirmed” at a different school may be ranked lower for the current school. Based on the ranking, the candidate recommendation module 208 identifies the top ranked desired number of candidates and recommends them to the school as leads, for example top 40 candidates may be recommended as leads.

### Admissions Cycle Time Line of a School

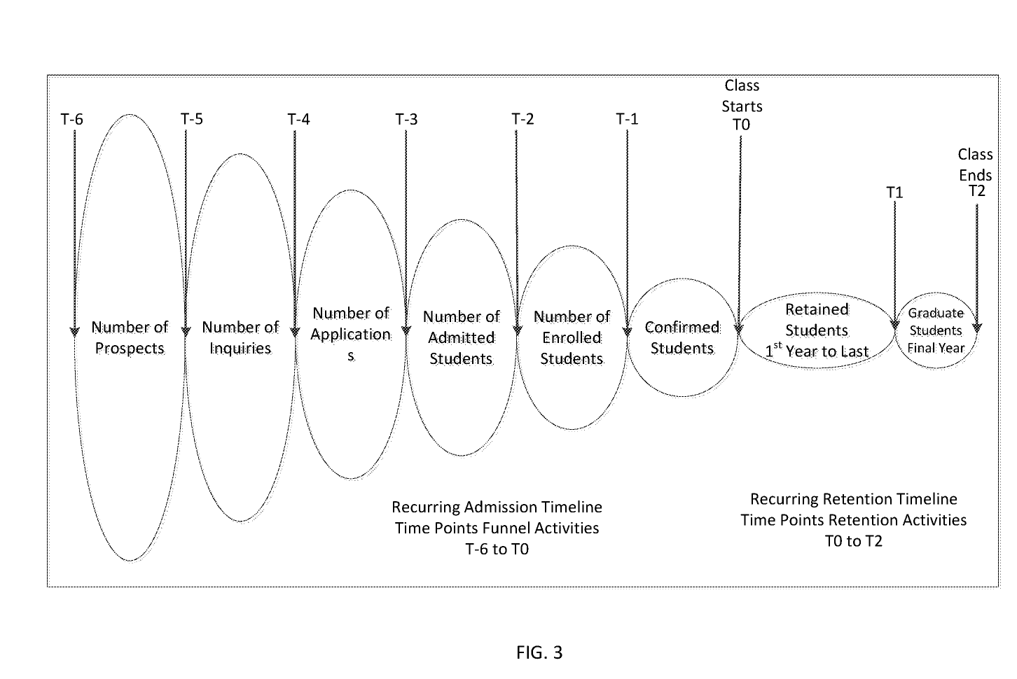

FIG. 3 explains in detail an admission cycle time line, according to an embodiment. The time line includes a time point T6 indicating a start of an admission cycle. At time point T6, a school may start looking for prospective students for a class. The school may send informational material related to courses offered at the school to the prospective students. At time point T5, the school may look into the number of inquiries it receives, based on the informational material that they sent out related to the school. Further at time point T4, the school may start looking into the number of applications received for a course for the specific year. Based on the school requirements to fill the class, for example, the number of seats available, the minimum grade point for the course, the academic background desired by the school, location of the school and other such factors, a school administrator may start analyzing the received applications. At any point between T6 to T3, the school may make a list of potential candidates and rank each candidate based on the school's requirements to fill up a class.

At some time between time point T4 and time point T3, the school administrator starts sending admits to applicants that match the school requirements for a class. At time point T3, the school starts determining the number of admitted students for a class. Based on the number of admits and, in one embodiment, based on the predicted admissions cycle, the school may make further decisions for filling up a class, for example, if they need to close admissions for a class, or send more admits to applicants of a specific class, or send admits based on certain academic criteria for a class and other such decisions. For example, the school may not have received enough admits to fill a class, but the predicted admissions cycle may indicate that a set of candidates may be enrolled by the end of time point T3, the school may consider including these set of candidates as tentatively enrolled, and accordingly send out further admits.

Based on the admission timeline of a school, the school may allow an admitted applicant to enroll for the course within a specific time period. For example, an applicant may enroll by accepting an admission offer. Between time points T2 and T1, a school receives enrollment information of the admitted students. The school then determines the number of enrolled students. At time point close to T1, if the number of enrolled students does not fill up the class, the school may make decisions such as sending out admits to students from the potential candidate list based on their ranking and based on the school requirements to fill up the class at point T1. For example, there may be 4 seats available to fill up a class and the school may require female applicants to fill up the 4 seats. The school administrator may look up the potential candidate list to find the first four top ranked candidates that match the requirement, and send them an admit letter. Between time T1 and T0, the school closes admissions by confirming enrollment of the admitted applicants. For example, an admitted applicant can confirm enrollment by depositing an enrollment fee.

At time T0, the classes start. Following time point T0, the admissions funnel process software application 110 keeps a track of retained students. Retained students are the students that were enrolled in the previous year(s) with the school. The retained students may or may not have progressed to the next year of school, for example, a student may progress from the freshman year to the sophomore year, or a student may not have completed enough credits to progress to the next year but does enroll to the school for concurrent academic years. At time point T1, after classes start, the admissions funnel process software application 110 may start accepting graduation applications for students. Students in the final year that meet the graduation requirements for a class may start applying between time point T1 and T2. By time point T2, classes for all students end. Additionally, by time T2, students meeting the graduate requirements may finish school and may not be eligible for re-enrollment to the same class.

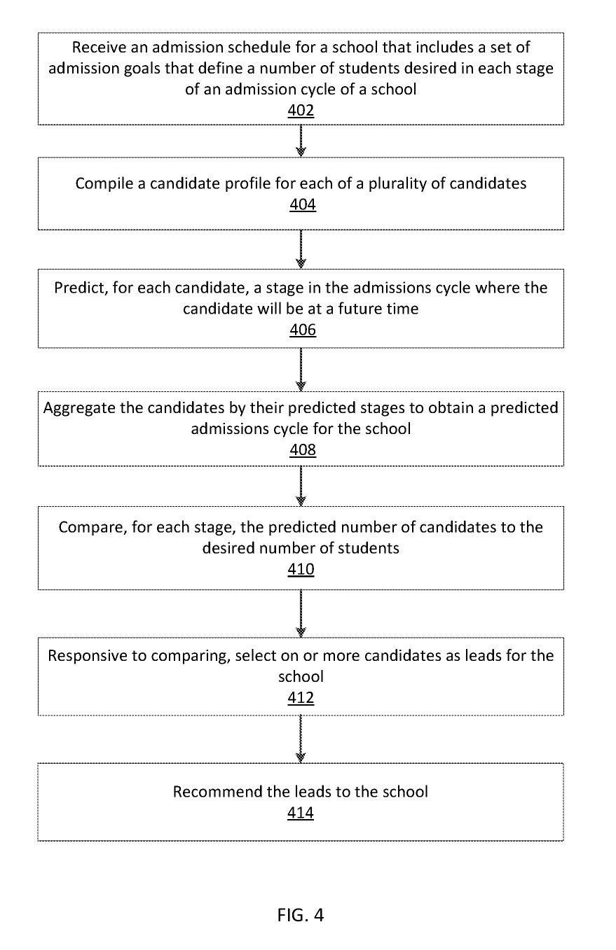

FIG. 4 is a flow chart illustrating the method for recommending a candidate to a school based on the current time point of an admission cycle of the school, according to one embodiment. The admissions funnel process software application 110 receives 402 an admission schedule for a school, the admission schedule includes a set of admission goals for the school. The admission goals may be a desired number of students at each stage of an admission cycle. Additionally, the admission goals may include an overall target enrollment, i.e. a desired number of students by the end of the admission cycle timeline or a retention target enrollment, i.e. a desired number of students that may be enrolled at the school for a subsequent year until graduation.

A candidate profile is compiled 404 for each of a plurality of candidates. The candidate profile that matches the school requirements is preferred. For each candidate, the admissions funnel process software application 110 predicts 406 a stage in the admission cycle that the candidate will be, at a future time. For example, a candidate enrolled in a first year with decent GPA is highly likely to be enrolled for the second year at the school, and thus is predicted to be at the confirmed stage at a future time. For each stage of an admission cycle, the candidates are aggregated 408 by their predicted stages to obtain a predicted admissions cycle for the school. For each stage, the aggregated predicted number of candidates is compared 410 to the desired number of candidates for that stage. For example the predicted number of candidates for an admitted stage of an admission cycle may be 40 and the desired number of candidates that were admitted may be 100. As a result of the comparison, the school may not have reached the desired admission goal, in the example, the desired goal was 100 and the predicted number may be 40. The school may be short by 60 candidates. The comparison may be done at any time point in the admission cycle. The comparison of the number of candidates for the admitted stage may be done before the time point T−6, i.e. at the prospects stage.

Responsive to the comparing, if the desired number of students is more than the predicted number of candidates for a stage, one or more candidates are selected 412 as leads by the admissions funnel process software application 110. The leads may be ranked based on the current stage of the admission cycle of the school, the profile of a candidate and the school requirements. The recommended leads are sent 414 to the school.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for recommending a candidate to a school, the method comprising:
receiving an admission schedule for a school that includes a set of admission goals that define a number of students desired in each of a set of stages in an admissions cycle of the school at a plurality of times during the admissions cycle for the school, wherein the admission cycle for a school includes one or more stages leading up to an enrollment of a student at the school;
compiling a candidate profile for each of a plurality of candidates;
predicting, using one or more prediction models, for each of one or more of the plurality of candidates, a stage in the admissions cycle where candidate will be at a future time;
aggregating the candidates by the predicted stages in the admissions cycle at the future time to obtain a predicted admissions cycle for the school;
comparing, for each stage of the admissions cycle, the number of desired students in an admission stage for the school to the number of candidates predicted to be in that admissions stage, the prediction obtained from the predicted admissions cycle for the future time;
responsive to the comparing, selecting one or more of the candidates as a lead for the school; and
sending the recommended leads to the school.

2. The method of claim 1, further comprising:
determining a list of potential candidates based on requirement of the school;
ranking, each candidate, from the list of potential candidates, based on a candidate qualifier of the candidate and a current admission stage of the school; and
selecting the top ranked desired number of candidates as leads for recommending to the school based on the admissions goals of the school.

3. The method of claim 1, further comprising predicting a time to decision for each candidate within a stage of the admission cycle timeline.

4. The method of claim 2, further comprising ranking each candidate from the list of potential candidates based on a candidate qualifier of the candidate at a school other than the present school.

5. The method of claim 1, further comprising providing a score, by one or more prediction models, the score indicating a likelihood of a candidate performing a candidate activity.

6. A computer program product for recommending a candidate to a school, the computer program product comprising a computer-readable storage medium containing computer program code for:
receiving an admission schedule for a school that includes a set of admission goals that define a number of students desired in each of a set of stages in an admissions cycle of the school at a plurality of times during the admissions cycle for the school, wherein the admission cycle for a school includes one or more stages leading up to an enrollment of a student at the school;
compiling a candidate profile for each of a plurality of candidates;
predicting, using one or more prediction models, for each of one or more of the plurality of candidates, a stage in the admissions cycle where candidate will be at a future time;
aggregating the candidates by the predicted stages in the admissions cycle at the future time to obtain a predicted admissions cycle for the school;
comparing, for each stage of the admissions cycle, the number of desired students in an admission stage for the school to the number of candidates predicted to be in that admissions stage, the prediction obtained from the predicted admissions cycle for the future time;
responsive to the comparing, selecting one or more of the candidates as a lead for the school; and
sending the recommended leads to the school.

7. The computer program product of claim 6, further comprising:
determining a list of potential candidates based on requirement of the school;
ranking, each candidate, from the list of potential candidates, based on a candidate qualifier of the candidate and a current admission stage of the school; and
selecting the top ranked desired number of candidates as leads for recommending to the school based on the admissions goals of the school.

8. The computer program product of claim 6, further comprising predicting a time to decision for each candidate within a stage of the admission cycle timeline.

9. The computer program product of claim 7, further comprising ranking each candidate from the list of potential candidates based on a candidate qualifier of the candidate at a school other than the present school.

10. The computer program product of claim 6, further comprising providing a score, by one or more prediction models, the score indicating a likelihood of a candidate performing a candidate activity.

11. A system for recommending a candidate to a school, the system configured to:
receive an admission schedule for a school that includes a set of admission goals that define a number of students desired in each of a set of stages in an admissions cycle of the school at a plurality of times during the admissions cycle for the school, wherein the admission cycle for a school includes one or more stages leading up to an enrollment of a student at the school;
compile a candidate profile for each of a plurality of candidates;
predict, using one or more prediction models, for each of one or more of the plurality of candidates, a stage in the admissions cycle where candidate will be at a future time;
aggregate the candidates by the predicted stages in the admissions cycle at the future time to obtain a predicted admissions cycle for the school;
compare, for each stage of the admissions cycle, the number of desired students in an admission stage for the school to the number of candidates predicted to be in that admissions stage, the prediction obtained from the predicted admissions cycle for the future time;
responsive to the comparing, selecting one or more of the candidates as a lead for the school; and
send the recommended leads to the school.

12. The system of claim 11, further configured to:
determine a list of potential candidates based on requirement of the school;
rank, each candidate, from the list of potential candidates, based on a candidate qualifier of the candidate and a current admission stage of the school; and
select the top ranked desired number of candidates as leads for recommending to the school based on the admissions goals of the school.

13. The system of claim 11, further configured to predict a time to decision for each candidate within a stage of the admission cycle timeline.

14. The system of claim 12, further configured to rank each candidate from the list of potential candidates based on a candidate qualifier of the candidate at a school other than the present school.

15. The system of claim 11, further configured to provide a score, by one or more prediction models, the score indicating a likelihood of a candidate performing a candidate activity.
